(19) United States
(12) Patent Application Publication
(10) Pub. No.: US 2018/0211142 A1
(43) Pub. Date: Jul. 26, 2018

(54) PRINTING SYSTEM FOR CUT SHEETS ON A PLURALITY OF MEDIA TYPES AND A METHOD THEREFOR

(71) Applicant: Océ Holding B.V., Venlo (NL)

(72) Inventor: Patrick G.H. VESTJENS, Venlo (NL)

(73) Assignee: Océ Holding B.V., Venlo (NL)

(21) Appl. No.: 15/870,648

(22) Filed: Jan. 12, 2018

(30) Foreign Application Priority Data
Jan. 26, 2017 (EP) 17153234.4

(51) Int. Cl. G06K 15/02; B41J 13/00

(52) U.S. Cl. CPC G06K 15/1809; G03G 2215/2045; B41J 13/0009; G06K 15/1823

(57) ABSTRACT

A printing system for cut sheets includes a controller for controlling the printing of image data on the cut sheets and scheduling the cut sheets in a printing order. The cut sheets have a plurality of media types, each media type having a dedicated preferred maximum speed for transporting the cut sheets of said media type along a paper path of the printing system. The controller is configured to schedule the cut sheets for printing taking into account change-over times between changes in media types of the scheduled cut sheets. The controller is further configured to calculate a first total time of printing the cut sheets including the change-over times, to determine a common speed for printing the cut sheets among the plurality of media types, to calculate a second total time of printing the cut sheets at the determined common speed excluding the change-over times, and, if the first total time is smaller than the second total time, to print the cut sheets at the corresponding dedicated preferred maximum speeds including change-over times, and, if the first total time is larger or equal to the second total time, to print the cut sheets at the determined common speed.

### FIELD OF THE INVENTION

The present invention relates to a printing system for cut sheets, the printing system comprising a controller for controlling the printing of image data on the cut sheets and scheduling the cut sheets in a printing order, the cut sheets having a plurality of media types, each media type having a dedicated preferred maximum speed for transporting the cut sheets of said media type along a print head or a print assembly of the printing system, the controller is configured to schedule the cut sheets for printing taking into account at least parts of change-over times between changes in media types of the scheduled cut sheets, the at least parts due to differences in the dedicated preferred maximum speeds for the plurality of media types.

### BACKGROUND OF THE INVENTION

The term “a dedicated speed” is meant to be a speed dedicated for a specific media type. Each media type has its own dedicated speed for processing the cut sheets in the printing system.

The term “a dedicated preferred speed” is meant to be a dedicated speed which is preferred for the corresponding media type. A dedicated preferred speed may be a maximum speed for the media type.

A dedicated speed—and also a dedicated preferred speed—for a media type is established, calculated or measured, by the manufacturer of the printing system before introducing the printing system on the market. Extensive tests on the printing system reveal per media type investigated dedicated speeds for the media type and a dedicated preferred speed for the media type. The established dedicated preferred speeds may be stored in the printing system or elsewhere as long as the printing system is configured to retrieve the established dedicated preferred speed for a media type when the printing system is intended to print on the media type.

The term “change-over time” is defined as a time needed to change a setup of electro-mechanics of the printing system, when switching from one media type to another. This may involve changing the media transport speed, a temperature set point, a fan speed, a height of the print heads, etc.

According to a paper path of a printing system each of the plurality of cut sheets is transported from an input section of the printing system towards a print head or print assembly. By means of the print head or print assembly marking material is disposed on each of the plurality of cut sheets. Each of the plurality of cut sheets may be guided from the print head or print assembly towards a surface of a functional component like a fixation drum for fixing the marking material to the cut sheets. The marking material may be ink which has to be dried or a toner which has to be fused to the cut sheets. To enable duplex printing the paper path may contain a loop, a so-called duplex loop. A cut sheet enters the loop in a first pass in order to print image data on one side of the cut sheet, goes through the duplex loop and enters the duplex loop in a second pass in order to print image data on the other side of the cut sheet. After a cut sheet has been printed upon on both sides, the cut sheet is transported to the output section for further finishing.

Patent application WO 2016/079160 reveals a printing system for cut sheets comprising a paper path with a loop.

Patent application WO 2016/177676 reveals a printing system comprising a sensor for checking the quality of sheet intended to be printed upon.

Patent application EP 3098709 reveals a method for determining pessimistic and optimistic print job durations for print jobs submitted to a printing system.

U.S. Pat. No. 5,956,543 reveals a printing system which comprises a media transport speed regulating mechanism.

Not all cut sheets can be printed at high speed, for example the maximum speed to be achieved by the printing system. Some media types, e.g. coated media, need to be printed at a lower speed than the maximum speed of the printing system. When printing on sheets of a plurality of media types that consist of both high- and low-speed media, traditionally the print speed of the printing system is changed by the controller of the printing system as to match the preferred maximum speed of the media along the print head or the print assembly. However, changing print speeds cost a substantial amount of time. This amount of time is at least a part of a change-over time from printing on a first media type to printing on a second media type.

### SUMMARY OF THE PRESENT INVENTION

It is an object of the present invention to provide a printing system that permits an increased and optimized productivity when printing on sheets of a plurality of media types.

In order to achieve this object, according to the invention, the controller is configured to calculate a first total time of printing the cut sheets including the at least parts of the change-over times, to determine a common speed for printing the cut sheets among the plurality of media types, to calculate a second total time of printing the cut sheets at the determined common speed excluding the at least parts of the change-over times, when the first total time is smaller than the second total time, to print the cut sheets at the corresponding dedicated preferred maximum speeds including the at least parts of the change-over times, and when the first total time is larger than or equal to the second total time, to print the cut sheets at the determined common speed excluding the at least parts of the change-over times.

The common speed is defined to be a speed which is acceptable for each media type of the plurality of media sheets and can be used when processing the cut sheets of the plurality of media types in the printing system. If for example, each media type has a number or range of acceptable speeds, the common speed for a plurality of media types may be determined to be a speed which for each media type of the plurality of media types is comprised in the number or range of acceptable speeds for the media type.

The present invention lies in optimizing productivity on printing cut sheets of mixed media by selectively printing on the cut sheets that could be printed at high speed, at low speed as well. By circumventing the change-over time between media types, which is in fact a time penalty involved by switching print speed, an overall productivity of the mixed media cut sheets will be higher, even though not printing at the highest speed possible for all sheets.

A decision making unit, a digital decision maker, residing in the controller determines what to do with the cut sheets that could be printed at high speed, in order to optimize overall productivity. The digital decision maker calculates a print time needed in either case—one case of changing print speeds and one case of no changing of print speeds—and then selecting the case with the shortest overall print time.

According to an embodiment the scheduled cut sheets belong to at least one print job in a print job queue of the printing system. When a print job queue of the printing system comprises a print job, the cut sheets for the print job may be scheduled at the appropriate print speeds for the media types of the cut sheets according to the invention. The appropriate print speeds are determined by the digital decision maker. When a print job queue of the printing system comprises a plurality of print jobs, all sheets together for the plurality of print jobs may be scheduled at the appropriate print speeds for the media types of the cut sheets according to the invention. The appropriate print speeds are determined by the digital decision maker. In this way the calculations with respect to the selected print speeds according to the invention are transcending a single print job.

According to an embodiment the controller comprises a digital media catalogue comprising for each media type a dedicated minimum speed and a dedicated preferred maximum speed. The common speed for printing the cut sheets among the plurality of media types is then determined by retrieving a minimum speed for each media type of a cut sheet of the plurality of cut sheets from a digital media catalogue residing in the printing system and taking a common speed higher than the minimum speeds.

The first total time of printing the cut sheets including the at least parts of the change-over times is then calculated by retrieving the dedicated preferred maximum speed for a media type of a cut sheet of the plurality of cut sheets from the digital media catalogue and summarizing these dedicated preferred maximum speeds multiplied by its application time together with the appropriate change-over times.

According to an embodiment the method comprises the step of determining a common speed which has as little as possible speed changes which occur while changing from printing on one media type to printing on another media type.

According to an embodiment the method comprises the step of determining a common speed which speed is a highest speed among possible common speeds.

The present invention also relates to a method for printing for cut sheets on a printing system, the method comprising the steps of scheduling the cut sheets in a printing order, the cut sheets having a plurality of media types, each media type having a dedicated preferred maximum speed for transporting the cut sheets of said media type along a print head or a print assembly of the printing system, and taking into account at least parts of change-over times between changes in media types of the scheduled cut sheets, the at least parts due to differences in the dedicated preferred maximum speeds for the plurality of media types, wherein the method comprises the further steps of calculating a first total time of printing the cut sheets including the at least parts of the change-over times, determining a common speed for printing the cut sheets among the plurality of media types, calculating a second total time of printing the cut sheets at the determined common speed excluding the at least parts of the change-over times, when the first total time is smaller than the second total time, printing the cut sheets at the corresponding dedicated preferred maximum speed including the at least parts of the change-over times, and when the first total time is larger than or equal to the second total time, printing the cut sheets at the determined common speed excluding the at least parts of the change-over times.

According to an embodiment the step of determining the common speed for printing the cut sheets among the plurality of media types comprises a step of retrieving a dedicated minimum speed for each media type of a cut sheet of the plurality of cut sheets from a digital media catalogue residing in the printing system, and the step of calculating the first total time of printing the cut sheets including the at least parts of the change-over times comprises the step of retrieving the dedicated preferred maximum speed for a media type of a cut sheet of the plurality of cut sheets from the digital media catalogue.

The invention also relates to a non-transitory software product comprising program code on a computer-readable medium, wherein said program code, when loaded into a computer that is connected to a printing system according to the invention causes the computer to act according to a method of the invention.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given here-in-below and the accompanying drawings which are given by way of illustration only, and thus are not limitative of the present invention, and wherein:

FIG. 1 is a schematic view of the printing system according to the invention;

FIG. 2 is a first schematic view of a row of scheduled cut sheets to be printed according to the invention;

FIG. 3 illustrates a diagram of the number of cut sheets as shown in FIG. 2 to be scheduled to be printed over time according to the invention;

FIG. 4 illustrates a diagram of another number of cut sheets to be scheduled to be printed over time according to the invention; and

FIG. 5 is a flow diagram of an embodiment of the method according to the invention.

### DETAILED DESCRIPTION OF THE PREFERRED EMBODIMENTS

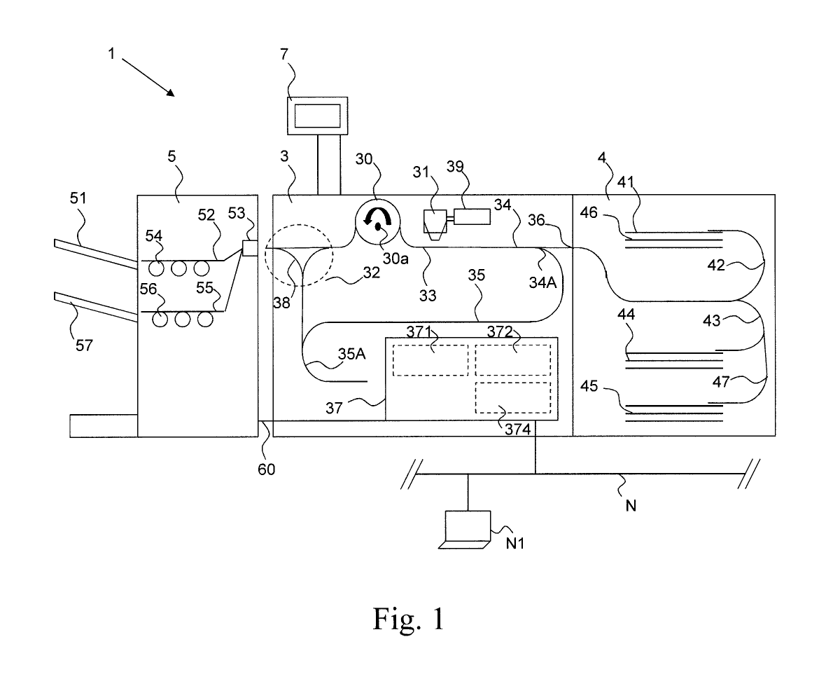

FIG. 1 shows schematically an embodiment of a printing system 1 according to the invention. The printing system 1, for purposes of explanation, is divided into an output section 5, a print engine and control section 3, a local user interface 7 and an input section 4. While a specific printing system is shown and described, the disclosed embodiments may be used with other types of printing system such as ink jet, electrographic, etc.

The output section 5 comprises a first output holder 52 for holding printed image receiving material, for example a plurality of cut sheets. The output section 5 may comprise a second output holder 55. The printed image receiving material is transported from the print engine and control section 3 via an inlet 53 to the output section 5. When a stack ejection command is invoked by the controller 37 for the first output holder 52, first guiding means 54 are activated in order to eject the plurality of cut sheets in the first output holder 52 outwards to a first external output holder 51. When a stack ejection command is invoked by the controller 37 for the second output holder 55, second guiding means 56 are activated in order to eject the plurality of cut sheets in the second output holder 55 outwards to a second external output holder 57.

The output section 5 is digitally connected by means of a cable 60 to the print engine and control section 3 for bi-directional data signal transfer.

The print engine and control section 3 comprises a print engine and a controller 37 for controlling the printing process and scheduling the plurality of cut sheets in a printing order before they are separated from input holder 44, 45, 46. The print engine comprises a print head or print assembly 31 for ejecting marking material on cut sheets transported along a paper path section 34.

The controller 37 is a computer, a server or a workstation, connected to the print engine and connected to the digital environment of the printing system, for example a network N for transmitting a submitted print job to the printing system 1. In FIG. 1 the controller 37 is positioned inside the print engine and control section 3, but the controller 37 may also be at least partially positioned outside the print engine and control section 3 in connection with the network N in a workstation N1.

The controller 37 comprises a print job receiving section 371 permitting a user to submit a print job to the printing system 1, the print job comprising image data to be printed and a plurality of print job settings. The controller 37 comprises a print job queue section 372 comprising a print job queue for print jobs submitted to the printing system 1 and scheduled to be printed. The controller 37 comprises a cut sheet scheduling section 374 for determining for each of the plurality of cut sheets of the print jobs in the print job queue an entrance time in the paper path of the print engine and control section 3, especially an entrance time for the first pass and an entrance time for the second pass in the duplex printing loop in the paper path according to the invention. By the determination of the entrance time of each sheet for the first pass and the second pass in the loop, the sheet scheduling section 374 also determines an inter sheet distance between subsequent sheets in the duplex printing loop. A loop time duration of a cut sheet going through the loop depends on the speed of the cut sheets in the loop. The loop time duration may vary per kind of cut sheet, i.e. a cut sheet of a different media type.

Resources may be cut sheets of media type material located in the input section 4, marking material located in a reservoir 39 near or in the print head or print assembly 31 of the print engine, or finishing material located near the print head or print assembly 31 of the print engine or located in the output section 5 (not shown).

The paper path comprises a plurality of paper path sections 32, 33, 34, 35 for transporting the image receiving material from an entry point 36 of the print engine and control section 3 along the print head or print assembly 31 to the inlet 53 of the output section 5. The paper path sections 32, 33, 34, 35 form a loop according to the invention. The loop enables the printing of a duplex print job or a mix-plex job, i.e. a print job comprising a mix of cut sheets intended to be printed partially in a simplex mode and partially in a duplex mode.

The print head or print assembly 31 is suitable for disposing marking material to the cut sheets. The print head or print assembly 31 is positioned near the paper path section 34. The print head or print assembly 31 may be an inkjet print head, a direct imaging toner assembly or an indirect imaging toner assembly.

While a cut sheet is transported along the paper path section 34 in a first pass in the loop, the sheet receives the marking material through the print head or print assembly 31. Directly downstream of the print head or print assembly 31 a functional component 30 is situated, for example, a fixation drum, a fixation belt, a fixation device, a drying device, a drying drum, a drying belt, a fusing device, a fusing belt, a fusing drum, etc. The functional component 30 may have a cylindrically shaped surface or any other rotatable surface around an axis 30a perpendicular to the drawing of FIG. 1. The surface may be an endless surface. The circumference is circular, ellipsoidal, belt-shaped. The functional component has at least one axis. The surface is configured to fix the marking material to the sheet or to dry the marking material on the sheet. The sheet is taken up at the right side of the functional component 30 and turned to the left side of the functional component 30. A next paper path section 32 is a flip unit 32 for selecting a different subsequent paper path for simplex or duplex printing of the image receiving material. The flip unit 32 may be also used to flip a cut sheet after printing in simplex mode before the sheet leaves the print engine and control section 3 via a curved section 38 of the flip unit 32 and via the inlet 53 to the output section 5. The curved section 38 of the flip unit 32 may not be present and the turning of a simplex page has to be done via another paper path section 35.

In case of duplex printing on a cut sheet or when the curved section 38 is not present, the sheet is transported along the loop via paper path section 35A in order to turn the sheet for enabling printing on the other side of the sheet. The sheet is transported along the paper path section 35 until it reaches a merging point 34A at which sheets entering the paper path section 34 from the entry point 36 interweave with the cut sheets coming from the paper path section 35. The cut sheets entering the paper path section 34 from the entry point 36 are starting their first pass along the print head or print assembly 31 in the loop. The cut sheets coming from the paper path section 35 are starting their second pass along the print head or print assembly 31 in the loop. When a cut sheet has passed the print head or print assembly 31 for the second time in the second pass, the sheet is guided along the functional component 30 and is further transported to the inlet 53 of the output section 5.

The input section 4 may comprise at least one input holder 44, 45, 46 for holding the image receiving material before transporting the cut sheets of image receiving material to the print engine and control section 3. Sheets of image receiving material are separated from the input holders 44, 45, 46 and guided from the input holders 44, 45, 46 by guiding means 42, 43, 47 to an outlet 36 for entrance in the print engine and control section 3. Each input holder 44, 45, 46 may be used for holding a different kind of image receiving material, i.e. sheets having different media properties, for example coated media and plain media, or colored media and white media, or one-color media and pre-printed media. The presence of a plurality of input holders allows printing of a mixed-media print job—also known as a multi-media print job, i.e. a print job comprising cut sheets of a plurality of media types.

The local user interface 7 is suitable for displaying user interface windows for controlling the print job queue residing in the controller 37. In another embodiment a computer N1 in the network N has a user interface for displaying and controlling the print job queue of the printing system 1.

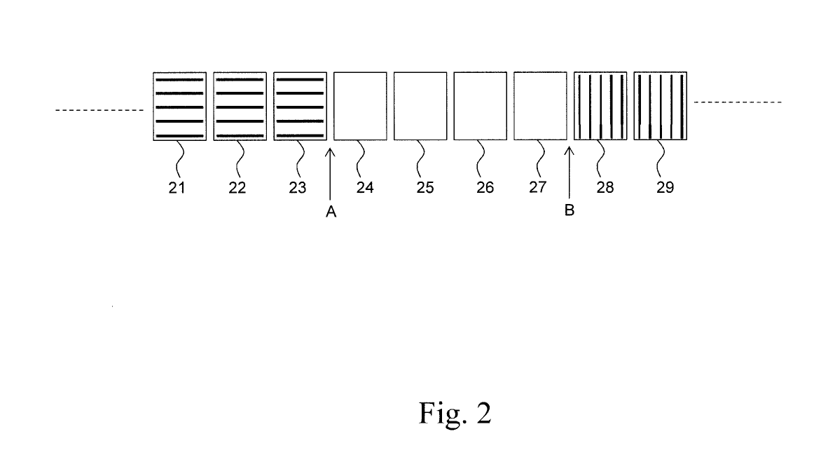

FIG. 2 is a first schematic view of a row of scheduled cut sheets 21-29 to be printed belonging to a print job scheduled in the print job queue of the printing system 1 according to the invention. Only a sequence order of the cut sheets 21-29 is shown. A time needed to process a cut sheet is not shown. To indicate a media type of cut sheet different shadings of the cut sheets 21-29 have been used. Cut sheets 21-23 are of a first media type, cut sheets 24-27 are of a second media type and cut sheets 28-29 are of a third media type. When a cut sheet media type is changing in a row of scheduled cut sheets 21-29 at the media switch positions A and B, a change-over time has to be taken into account. Cut sheets scheduled before and after the cut sheets 21-29 are not displayed for convenience reason but may be present in the controller 37 of the printing system 1 as scheduled sheets.

A decision making unit, a digital decision maker, residing in the controller 37 determines what to do with the cut sheets that could be printed at high speed, in order to optimize overall productivity. The digital decision maker calculates a print time needed in either case—one case of changing print speeds and one case of no changing of print speeds—and then selecting the case with the shortest overall print time.

According to an embodiment the controller 37 comprises a digital media catalogue comprising for each media type a dedicated minimum speed and a dedicated preferred maximum speed. The common speed for printing the cut sheets among the plurality of media types is then determined by retrieving the dedicated minimum speed for each media type of a cut sheet of the plurality of cut sheets from a digital media catalogue residing in the printing system. Then as a common speed a minimum of these dedicated minimum speeds may be taken or a highest common speed among the media types or a common speed with as little as possible speed changes which occur while changing from printing on one media type to printing on another media type.

For each media type a common range from the dedicated minimum speed to the preferred maximum speed may be determined. A common speed may be any speed that lies in all common ranges of the plurality of media types. Preferred is a common speed that lies in all common ranges and is maximal.

The first total time of printing the cut sheets including the at least parts of the change-over times is then calculated by retrieving the dedicated preferred maximum speed for a media type of a cut sheet of the plurality of cut sheets from the digital media catalogue and summarizing these dedicated preferred maximum speeds multiplied by the corresponding application time of the preferred maximum speed together with the appropriate change-over times.

The change-over times for the media switch positions A and B may be retrieved from software plug-ins in the controller 37. A plug-in may be for example available for the paper path section 34 of the printing system 1 and for the functional component 30 of the printing system 1. Both plug-ins indicate how much time is needed to switch from the speed of the previous cut sheet of the first media type to the needed speed for the next sheet of the second media type at the media switch position A and to switch from the speed of the previous cut sheet of the second media type to the needed speed for the next sheet of the third media type at the media switch position B.

In the media catalogue a plurality of speeds may be registered for each media type. One speed of the plurality of speeds is the dedicated minimum speed for the media type. Another one of the plurality of speeds is the dedicated preferred typically maximum speed for the media type. The scheduler uses this information in order to determine which combination of speeds is most productive. Therefore the cut sheet scheduling section 374 in the controller 37 queries the plug-ins several times in order to determine the penalties for speed changes at the media switch positions A and B in order to achieve input for the digital decision maker.

The scheduled cut sheets 21-29 may belong to a print job residing in the print job queue of the printing system 1. When a print job queue of the printing system comprises a print job, the cut sheets for the print job may be scheduled at the appropriate print speeds for the media types of the cut sheets according to the invention. When a print job queue of the printing system comprises a plurality of print jobs, all sheets together for the plurality of print jobs may be scheduled at the appropriate print speeds for the media types of the cut sheets according to the invention. In this way the calculations with respect to the selected print speeds according to the invention are transcending the sheets of a single print job.

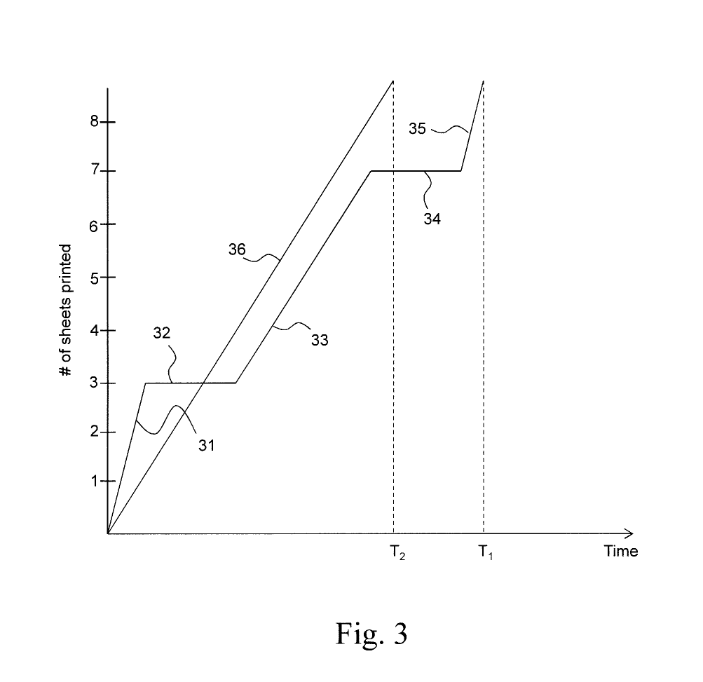

FIG. 3 illustrates a diagram of the number of cut sheets 21-29 as shown in FIG. 2 to be scheduled to be printed over time.

FIG. 3 shows consecutive line segments 31-35 representing the printing of the cut sheets 21-29 when each cut sheet is printed at a speed which is dedicated and preferred according to the media type of the cut sheet. Change-over times are illustrated by means of the line segments with reference numbers 32 and 34.

FIG. 3 also shows a line 36 representing the printing of all cut sheets 21-29 at a low common speed. Line 36 does not include any change-over time.

A first line segment 31 shows the printing of the cut sheets 21-23 at a relative high speed as can be concluded from the inclination of the line segment 31. The relative high speed is the preferred maximum speed for cut sheets 21-23 of the first media type.

A second line segment 32 shows a first change-over time from a preferred maximum speed of a third cut sheet 23 of the first media type to a preferred maximum speed of a fourth cut sheet 24 of the second media type since the third cut sheet 23 consists of another media type than the fourth cut sheet 24 and has another dedicated preferred maximum speed prescribed by the controller 37 than the fourth cut sheet 24.

A third line segment 33 shows the printing of the cut sheets 24-27 at a low speed in comparison with the relative high speed in the first line segment 31. The low speed is the preferred maximum speed for the cut sheets 24-27 of the second media type.

A fourth line segment 34 shows a second change-over time from a preferred maximum speed of a seventh cut sheet 27 of the second media type to a preferred maximum speed of an eighth cut sheet 28 of a third media type since the seventh cut sheet 27 consists of another media type than the eighth cut sheet 28 and has another dedicated preferred maximum speed prescribed by the controller 37 than the third media type.

A fifth line segment 35 shows the printing of the cut sheets 28-29 at a relative high speed in comparison with the low speed in the third line segment 33. The relative high speed is the preferred maximum speed for the cut sheets 28-29 of the third media type.

Another line 36 shows the printing of all cut sheets 21-29 at a low common print speed which is equal to the print speed used in the third line segment 33 for the cut sheets 24-27 of the second media type. It is assumed that there are no constraints imposed by the controller 37 to print the sheets 21-23 of the first media type and the sheets 28-29 of the third media type at this low common speed. If there are constraints imposed by the controller 37 the low common speed would be selected to be higher than the low common speed shown according to line 36. For example, a common speed may be selected with has, when applied, as little as possible speed changes during media switches. For example, a common speed may be selected which is a highest common speed among the media types.

When printing the cut sheets 21-29 according to the line segments 31-35 the printing of the cut sheets 21-29 will cost a first amount of time T₁.

When printing the cut sheets 21-29 according to the line 36 the printing of the cut sheets 21-29 will cost a second amount of time T₂.

Since the first amount of time T₁ is larger than the second amount of time T₂, the controller 37 will decide to print the cut sheets 21-29 according to the line 36 at a low common speed for all cut sheets 21-29.

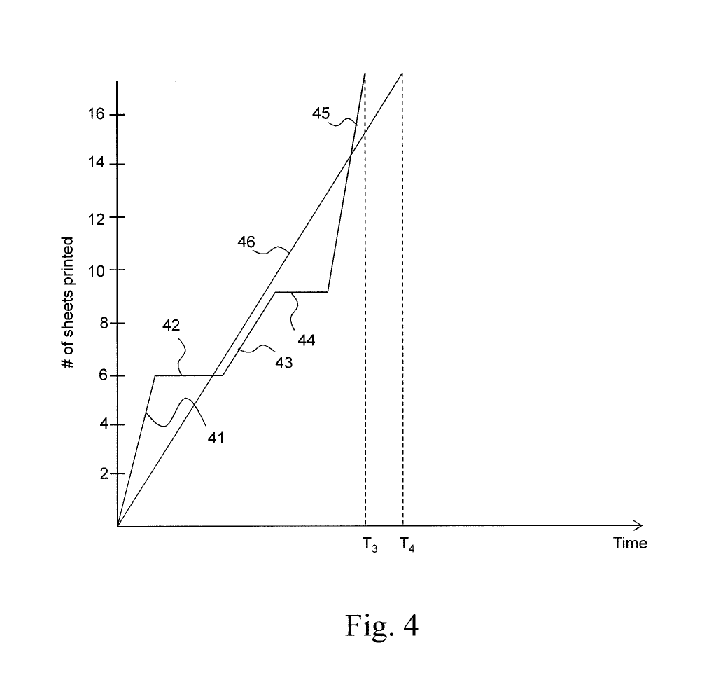

FIG. 4 illustrates a diagram of a number of eighteen cut sheets (not shown) to be scheduled to be printed over time.

FIG. 4 shows consecutive line segments 41-45 representing the printing of the eighteen cut sheets of three different media types when each cut sheet is printed at a speed which is dedicated and preferred according to the media type of the cut sheet. Change-over times are hereby included as the line segments with reference numbers 42 and 44.

FIG. 4 also shows a line 46 representing the printing of the eighteen cut sheets at a low common speed. Line 46 does not include any change-over time.

The line 46 shows the printing of all eighteen cut sheets at a low minimum print speed corresponding to a preferred maximum speed of one of the media types of the cut sheets. It is assumed that there are no constraints imposed by the controller 37 to print the sheets of the other media types at this low common speed.

When printing the eighteen cut sheets according to the line segments 41-45 the printing of the cut sheets will cost a third amount of time T₃.

When printing the eighteen cut sheets according to the line 46 the printing of the cut sheets will cost a fourth amount of time T₄.

Since the fourth amount of time T₄ is larger than the third amount of time T₃, the controller 37 will decide to print the eighteen cut sheets according to the line segments 41-45 at a dedicated preferred maximum speed for each media type of the sheets with change-over times.

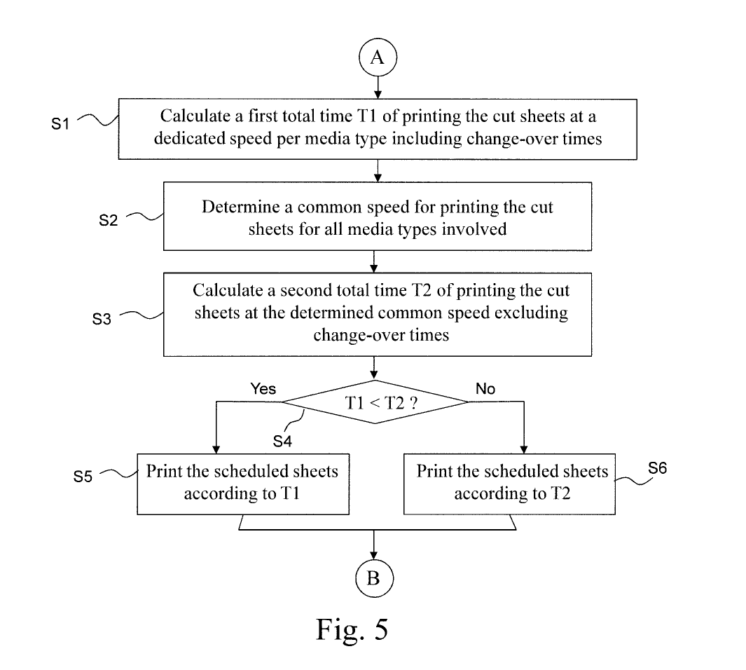

FIG. 5 is a flow diagram of an embodiment of the method according to the invention. The method is suitable for scheduling the cut sheets in a printing order. The cut sheets have a plurality of media types. Each media type has a dedicated preferred maximum speed for transporting the cut sheets of said media type along a print head or a print assembly of a printing system according to the invention. At least parts of change-over times between changes in media types of the scheduled cut sheets are taken into account. The at least parts of the change-over times are due to differences in the dedicated preferred maximum speeds for the plurality of media types.

The method starts in starting point A and leads to a first step S1.

In the first step S1 a first total time of printing the cut sheets at the media type dedicated and preferred maximum speeds including the at least parts of the change-over times is calculated.

In a second step S2 a common speed is determined for printing the cut sheets among the plurality of involved media types.

In a third step S3 a second total time of printing the cut sheets at the determined common speed excluding the at least parts of the change-over times is calculated. Several embodiments of determining the common speed have been elucidated here-before.

In a fourth step S4 it is checked whether the first total time is smaller than the second total time. If so, the method proceeds to a fifth step S5, otherwise the method proceeds to a sixth step S6.

In the fifth step S5 the cut sheets are scheduled and printed at the corresponding dedicated preferred maximum speed with respect to the media types of the sheets including the at least parts of the change-over times.

In the sixth step S6, the cut sheets are scheduled and printed at the determined common speed excluding the at least parts of the change-over times. It is noted that, when the first total time equals the second total time, also the sixth step S6 will be executed due to less wear on the moving elements of the print head, paper path, a potential fixing unit of the printing system 1.

The method ends in an end point B.

The described embodiments of the printing system according to the invention may be varied upon and/or combined according to skills of a skilled person in the art.

The described embodiments of the method according to the invention may be varied upon and/or combined according to the skills of a skilled person in the art.

The skilled person will recognize that other embodiments are possible within the scope of the appended claims.

1. A printing system for cut sheets, the printing system comprising:
a controller for controlling the printing of image data on the cut sheets and scheduling the cut sheets in a printing order, the cut sheets having a plurality of media types, each media type having a dedicated preferred maximum speed for transporting the cut sheets of said media type along a print head or a print assembly of the printing system,
wherein the controller is configured:
to schedule the cut sheets for printing taking into account at least parts of change-over times between changes in media types of the scheduled cut sheets, the at least parts due to differences in the dedicated preferred maximum speeds for the plurality of media types;
to calculate a first total time of printing the cut sheets with the preferred maximum print speeds for the plurality of media types including the at least parts of the change-over times;
to determine a common speed for printing the cut sheets of the plurality of media types;
to calculate a second total time of printing the cut sheets at the determined common speed excluding the at least parts of the change-over times;
when the first total time is smaller than the second total time, to print the cut sheets at the corresponding dedicated preferred maximum speeds including the at least parts of the change-over times; and
when the first total time is larger than or equal to the second total time, to print the cut sheets at the determined common speed excluding the at least parts of the change-over times.

2. The printing system according to claim 1, wherein the scheduled cut sheets belong to at least one print job in a print job queue of the printing system.

3. The printing system according to claim 1, wherein the controller comprises a digital media catalogue comprising for each media type a dedicated minimum speed and a dedicated preferred maximum speed.

4. A method for printing for cut sheets on a printing system, the method comprising the steps of:
scheduling the cut sheets in a printing order, the cut sheets having a plurality of media types, each media type having a dedicated preferred maximum speed for transporting the cut sheets of said media type along a print head or a print assembly of the printing system;
taking into account at least parts of change-over times between changes in media types of the scheduled cut sheets, the at least parts due to differences in the dedicated preferred maximum speeds for the plurality of media types;
calculating a first total time of printing the cut sheets with the preferred maximum speeds for the plurality of media types including the at least parts of the change-over times;
determining a common speed for printing the cut sheets among the plurality of media types;
calculating a second total time of printing the cut sheets at the determined common speed excluding the at least parts of the change-over times;
when the first total time is smaller than the second total time, printing the cut sheets at the corresponding dedicated preferred maximum speed including the at least parts of the change-over times; and
when the first total time is larger than or equal to the second total time, printing the cut sheets at the determined common speed excluding the at least parts of the change-over times.

5. The method according to claim 4, wherein the step of determining the common speed for printing the cut sheets among the plurality of media types comprises a step of retrieving the dedicated minimum speed for each media type of a cut sheet of the plurality of cut sheets from a digital media catalogue residing in the printing system, and the step of calculating the first total time of printing the cut sheets including the at least parts of the change-over times comprises the step of retrieving the dedicated preferred maximum speed for a media type of a cut sheet of the plurality of cut sheets from the digital media catalogue.

6. The method according to claim 5, wherein the step of determining the common speed comprises the step of determining the common speed which has as little as possible speed changes which occur while changing from printing on one media type to printing on another media type.

7. The method according to claim 5, wherein the step of determining the common speed comprises the step of determining a common speed which speed is a highest speed among possible common speeds.

8. A non-transitory software product comprising program code on a computer-readable medium, wherein said program code, when loaded into a computer that is connected to a printing system causes the computer to act according to the method of claim 4.
